(19) United States
(12) Patent Application Publication
(10) Pub. No.: US 2025/0329856 A1
(43) Pub. Date: Oct. 23, 2025

(54) POWER STORAGE DEVICE

(71) Applicant: TOYOTA JIDOSHA KABUSHIKI KAISHA, Toyota-shi (JP)

(72) Inventors: Shigeyuki INOUE, Toyota-shi (JP); Naoya KAWAMOTO, Nisshin-shi (JP); Takahito SAKURABA, Seto-shi (JP); Kenichi KAKISHITA, Nagoya-shi (JP); Kohei TAKASE, Susono-shi (JP); Kai MIYAMURA, Toyota-shi (JP); Kazuya KUMAZAWA, Nagoya-shi (JP)

(73) Assignee: TOYOTA JIDOSHA KABUSHIKI KAISHA, Toyota-shi (JP)

(21) Appl. No.: 19/073,870

(22) Filed: Mar. 7, 2025

(30) Foreign Application Priority Data
Apr. 18, 2024 (JP) 2024-067307

(51) Int. Cl. H01M 50/289; B60K 1/04; H01M 50/209; H01M 50/249

(52) U.S. Cl. CPC H01M 50/289; H01M 50/209; H01M 50/249; B60K 1/04; H01M 2220/20

(57) ABSTRACT

In a power storage device, a plurality of cells are arranged in a first direction. A plurality of buffer portions are disposed on the plurality of cells. Each of the plurality of cells includes an upper surface portion facing upward. The upper surface portion includes a first end edge and a second end edge. The first end edge and the second end edge extend along a second direction, the second direction being a direction along the horizontal direction and orthogonal to the first direction. The plurality of buffer portions are spaced apart from each other on the upper surface portions of the plurality of cells, and at least one of the plurality of buffer portions is provided at at least one of the first end edge and the second end edge of each of the plurality of cells.

### CROSS REFERENCE TO RELATED APPLICATIONS

This nonprovisional application is based on Japanese Patent Application No. 2024-067307 filed on Apr. 18, 2024 with the Japan Patent Office, the entire contents of which are hereby incorporated by reference.

### BACKGROUND

### Field

The present disclosure relates to a power storage device.

### Description of the Background Art

Japanese Patent Laying-Open No. 2020-142589 discloses that a battery pack is disposed on the lower side of a floor panel.

### SUMMARY

A structure of a power storage device mountable on a vehicle, which can achieve higher energy density of the power storage device, has been considered. For example, it has been considered to dispose a power storage device below a floor panel and as close as possible to the floor panel, or to cause a power storage device itself to constitute a part of a floor panel. However, when the power storage device is designed as described above, a load may be input from above the power storage device due to a load from the inside of a vehicle compartment, i.e., a load from the upper side.

The present disclosure has been made in view of the above-described problem, and an object of the present disclosure is to provide a power storage device having high rigidity against input of a load from above.

A power storage device according to an aspect of the present disclosure is mountable on a vehicle. The power storage device includes: a plurality of cells; and a plurality of buffer portions. The plurality of cells are arranged in a first direction, the first direction being a direction along a horizontal direction. The plurality of buffer portions are disposed on the plurality of cells. Each of the plurality of cells includes an upper surface portion facing upward. The upper surface portion includes a first end edge and a second end edge. The first end edge is an end edge on one side in the first direction. The second end edge is an end edge on the other side in the first direction. The first end edge and the second end edge extend along a second direction, the second direction being a direction along the horizontal direction and orthogonal to the first direction. The plurality of buffer portions are spaced apart from each other on the upper surface portions of the plurality of cells, and at least one of the plurality of buffer portions is provided at at least one of the first end edge and the second end edge of each of the plurality of cells.

In the power storage device according to the aspect of the present disclosure, preferably, the plurality of buffer portions are spaced apart from each other on the upper surface portions of the plurality of cells, and at least one of the plurality of buffer portions is provided at the first end edge of each of the plurality of cells and at least one of the plurality of buffer portions is provided at the second end edge of each of the plurality of cells.

In the power storage device according to the aspect of the present disclosure, preferably, buffer portions provided on different cells and being adjacent to each other in the first direction, of the plurality of buffer portions, are continuous to each other.

The power storage device according to the aspect of the present disclosure preferably further includes a plate-shaped portion. The plate-shaped portion is provided to cover the plurality of buffer portions. The plurality of buffer portions are formed integrally with the plate-shaped portion.

The power storage device according to the aspect of the present disclosure preferably further includes an elastic member. The elastic member is disposed on the upper surface portion of at least one of the plurality of cells in a gap between the plurality of buffer portions.

The power storage device according to the aspect of the present disclosure preferably further includes a pack. The pack houses the plurality of cells having the plurality of buffer portions provided thereon. The pack is fixable to a vehicle body of the vehicle. The plurality of buffer portions are formed integrally with the pack.

The power storage device according to the aspect of the present disclosure preferably further includes a plurality of spacers. Each of the plurality of spacers is disposed between corresponding two cells adjacent to each other, of the plurality of cells. The plurality of spacers are formed integrally with the plurality of buffer portions.

In the power storage device according to the aspect of the present disclosure, preferably, each of the plurality of cells includes an electrode assembly and a cell case. The cell case houses the electrode assembly. The plurality of buffer portions are formed integrally with the cell cases by bending the cell cases of the plurality of cells convexly outward.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a schematic view showing a vehicle on which a power storage device according to a first embodiment of the present disclosure is mounted.

FIG. 2 is a schematic perspective view showing a vehicle body of the vehicle on which the power storage device according to the first embodiment of the present disclosure is mounted.

FIG. 3 is a schematic cross-sectional view of a part of the vehicle in FIG. 1 when viewed in the direction of an arrow III-III.

FIG. 4 is a plan view showing the power storage device according to the first embodiment of the present disclosure together with cross members of the vehicle body.

FIG. 5 is an exploded perspective view showing the power storage device according to the first embodiment of the present disclosure.

FIG. 6 is a cross-sectional view of the power storage device in FIG. 4 when viewed in the direction of an arrow VI-VI.

FIG. 7 is a schematic cross-sectional view of a power storage module.

FIG. 8 is a cross-sectional view of the power storage device in FIG. 4 when viewed in the direction of an arrow VIII-VIII.

FIG. 9 is a cross-sectional view showing a power storage device according to a modification of the first embodiment of the present disclosure.

FIG. 10 is a partial cross-sectional view showing a power storage device according to a second embodiment of the present disclosure.

FIG. 11 is a partial cross-sectional view showing a power storage device according to a third embodiment of the present disclosure.

FIG. 12 is a cross-sectional view showing a power storage device according to a fourth embodiment of the present disclosure.

FIG. 13 is a cross-sectional view showing a power storage device according to a modification of the fourth embodiment of the present disclosure.

FIG. 14 is a partial cross-sectional view showing a power storage device according to a fifth embodiment of the present disclosure.

FIG. 15 is a partial cross-sectional view showing a power storage device according to a sixth embodiment of the present disclosure.

### DESCRIPTION OF THE PREFERRED EMBODIMENTS

Hereinafter, a power storage device according to each embodiment of the present disclosure will be described with reference to the drawings. In the following drawings, the same or corresponding portions are denoted by the same reference characters and description thereof will not be repeated.

### First Embodiment

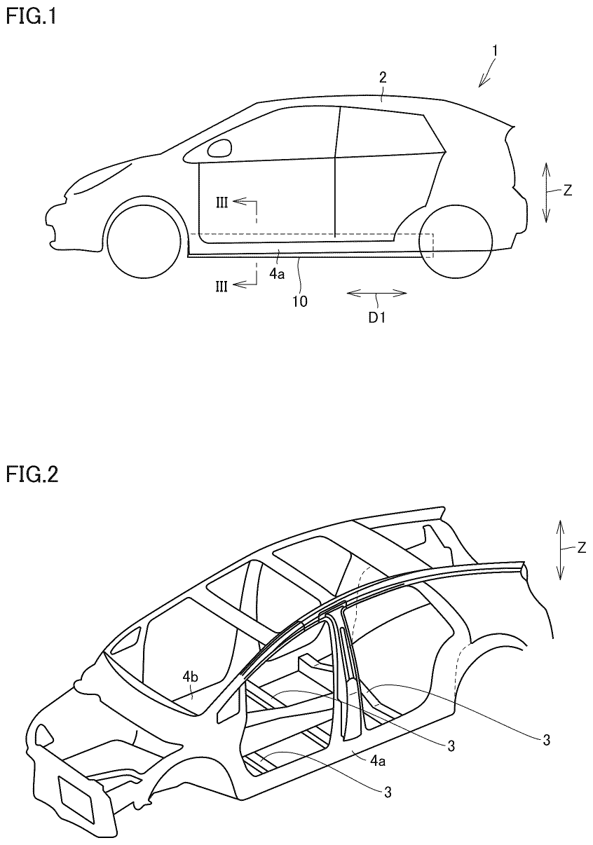

FIG. 1 is a schematic view showing a vehicle on which a power storage device according to a first embodiment of the present disclosure is mounted. As shown in

FIG. 1, a power storage device 10 according to the first embodiment of the present disclosure is power storage device 10 mountable on a vehicle 1. Vehicle 1 will be described first.

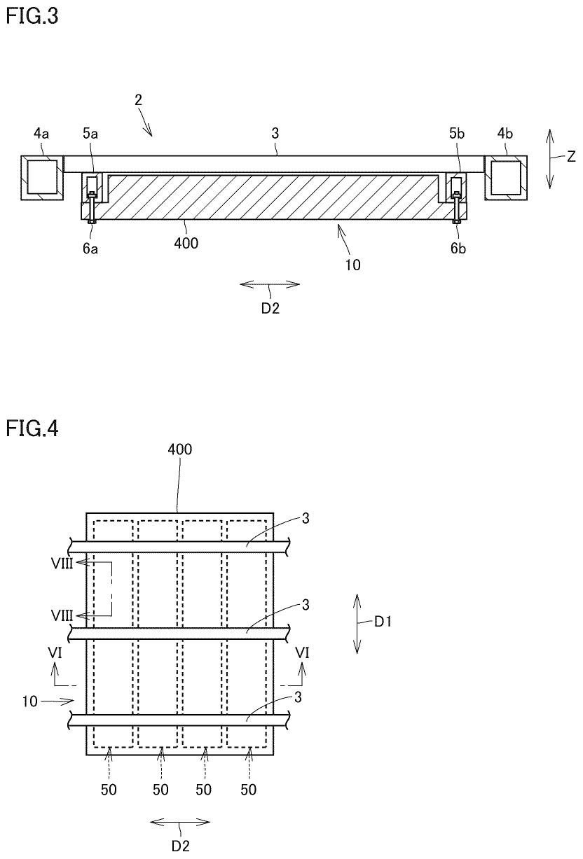

Vehicle 1 according to the first embodiment is, for example, an electrically powered vehicle such as an electric vehicle or a hybrid vehicle that can be driven by a motor. FIG. 2 is a schematic perspective view showing a vehicle body of the vehicle on which the power storage device according to the first embodiment of the present disclosure is mounted. FIG. 3 is a schematic cross-sectional view of a part of the vehicle in FIG. 1 when viewed in the direction of an arrow III-III. As shown in FIGS. 1 to 3, vehicle 1 according to the first embodiment of the present disclosure includes power storage device 10 and a vehicle body 2 to which power storage device 10 is fixed. A front-rear direction of vehicle 1 or vehicle body 2 is parallel to a below-described first direction D1 in power storage device 10.

Vehicle body 2 includes, as frame members of vehicle 1, a plurality of cross members 3, a left side sill 4a, a right side sill 4b, a left side member 5a, and a right side member 5b.

Each of the plurality of cross members 3 extends in a left-right direction of vehicle body 2. The left-right direction or a vehicle width direction of vehicle 1 or vehicle body 2 is parallel to a below-described second direction D2 in power storage device 10. The plurality of cross members 3 are arranged in first direction D1. Vehicle body 2 may include only one cross member 3.

Left side sill 4a is disposed on the left side in the left-right direction of vehicle 1. Left side sill 4a extends in the front-rear direction of vehicle 1. Right side sill 4b is disposed on the right side in the left-right direction of vehicle 1. Right side sill 4b extends in the front-rear direction of vehicle 1. Each of the plurality of cross members 3 extends from the inner side of left side sill 4a to the inner side of right side sill 4b.

Left side member 5a is disposed on the left side in the left-right direction of vehicle 1. Left side member 5a extends in the front-rear direction of the vehicle. Left side member 5a is disposed closer to the vehicle center in the vehicle width direction than left side sill 4a. Right side member 5b is disposed on the right side in the left-right direction of vehicle 1. Right side member 5b is disposed closer to the vehicle center in the vehicle width direction than right side sill 4b.

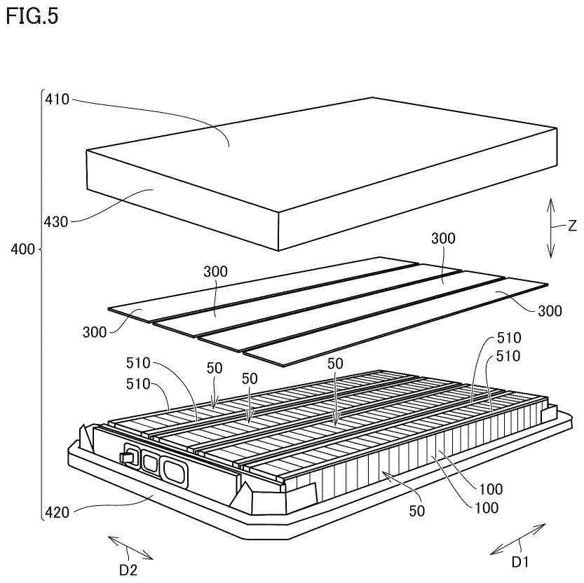

Details of power storage device 10 according to the first embodiment of the present disclosure will now be described. FIG. 4 is a plan view showing the power storage device according to the first embodiment of the present disclosure together with the cross members of the vehicle body.

As shown in FIGS. 3 and 4, power storage device 10 includes a plurality of power storage modules 50. The plurality of power storage modules 50 are disposed below cross members 3.

Each of the plurality of power storage modules 50 extends in first direction D1. First direction D1 is a direction along a horizontal direction. When viewed in an up-down direction Z, each of the plurality of power storage modules 50 is disposed to intersect at least one cross member 3. When viewed in up-down direction Z, each of the plurality of power storage modules 50 is disposed to intersect the plurality of cross members 3. The plurality of power storage modules 50 are arranged in second direction D2. Second direction D2 is a direction along the horizontal direction. Second direction D2 is a direction orthogonal to first direction D1. In the present embodiment, the plurality of power storage modules 50 are arranged only in second direction D2.

Power storage device 10 may include at least one power storage module 50. Power storage device 10 may include only one power storage module 50. The plurality of power storage modules 50 may be arranged in first direction D1. The plurality of power storage modules 50 may be arranged in first direction D1 and arranged in second direction D2. The plurality of power storage modules 50 may be arranged only in first direction D1.

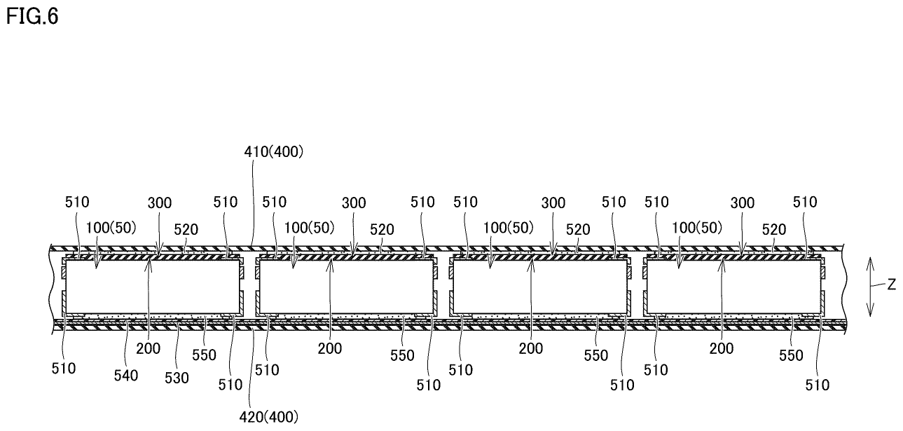

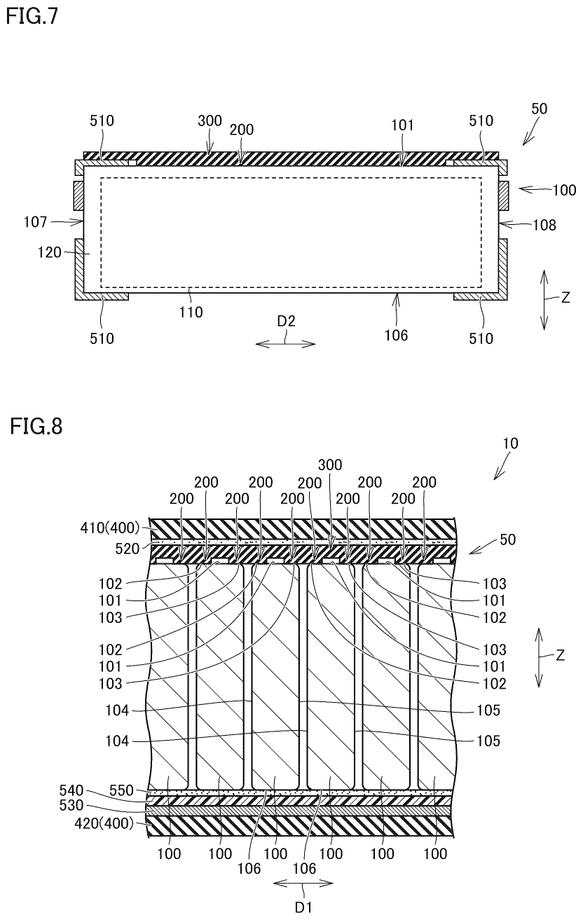

Next, details of power storage modules 50 will be described. FIG. 5 is an exploded perspective view showing the power storage device according to the first embodiment of the present disclosure. FIG. 6 is a cross-sectional view of the power storage device in FIG. 4 when viewed in the direction of an arrow VI-VI. FIG. 7 is a schematic cross-sectional view of the power storage module. FIG. 7 is illustrated in the same cross-sectional view as FIG. 6. FIG. 8 is a cross-sectional view of the power storage device in FIG. 4 when viewed in the direction of an arrow VIII-VIII.

As shown in FIGS. 5 to 8, each of the plurality of power storage modules 50 includes a plurality of cells 100, a plurality of buffer portions 200 (see FIG. 8), and a plate-shaped portion 300.

Each of the plurality of cells 100 is, for example, a non-aqueous electrolyte secondary battery such as a lithium ion secondary battery. The plurality of cells 100 are arranged in first direction D1.

Each of the plurality of cells 100 has an upper surface portion 101 facing upward. Upper surface portion 101 has a first end edge 102 and a second end edge 103. First end edge 102 is an end edge on one side in first direction D1. Second end edge 103 is an end edge on the other side in first direction D1. First end edge 102 and second end edge 103 extend along second direction D2, second direction D2 being a direction along the horizontal direction and orthogonal to first direction D1.

Each of the plurality of cells 100 further has a first end surface portion 104, a second end surface portion 105, a bottom surface portion 106, a first side surface portion 107, and a second side surface portion 108. First end surface portion 104 extends downward from first end edge 102. Second end surface portion 105 extends downward from second end edge 103. Bottom surface portion 106 is located opposite to upper surface portion 101. Bottom surface portion 106 is connected to first end surface portion 104 and second end surface portion 105.

First side surface portion 107 faces one side in second direction D2. Second side surface portion 108 faces the other side in second direction D2. First side surface portion 107 and second side surface portion 108 are connected to upper surface portion 101, first end surface portion 104, second end surface portion 105, and bottom surface portion 106.

Each of the plurality of cells 100 includes an electrode assembly 110 and a cell case 120. Electrode assembly 110 includes a positive electrode layer, a negative electrode layer and a separator (all are not shown). The separator is interposed between the positive electrode layer and the negative electrode layer. The positive electrode layer and the negative electrode layer may be stacked in first direction D1 with the separator interposed therebetween. The positive electrode layer and the negative electrode layer may be wound with second direction D2 as an axial direction, in a state where the separator is interposed therebetween.

Cell case 120 houses electrode assembly 110. Cell case 120 may be made of metal such as aluminum or an aluminum alloy. Cell case 120 constitutes at least a part of each of upper surface portion 101, first end surface portion 104, second end surface portion 105, and bottom surface portion 106. Cell case 120 constitutes at least first end edge 102 and second end edge 103. Cell case 120 has a so-called rectangular shape.

In cell case 120, first end edge 102 and second end edge 103 may be connected to first end surface portion 104 and second end surface portion 105 by welding, respectively. First end edge 102 and second end edge 103 may be formed by bending cell case 120.

The plurality of buffer portions 200 are disposed on the plurality of cells 100. The plurality of buffer portions 200 are spaced apart from each other on upper surface portions 101 of the plurality of cells 100, and at least one of the plurality of buffer portions 200 is provided at at least one of first end edge 102 and second end edge 103 of each of the plurality of cells 100. The plurality of buffer portions 200 are spaced apart from each other on upper surface portions 101 of the plurality of cells 100, and at least one of the plurality of buffer portions 200 is provided at first end edge 102 of each of the plurality of cells 100 and at least one of the plurality of buffer portions 200 is provided at second end edge 103 of each of the plurality of cells 100. Buffer portions 200 provided on different cells 100 and being adjacent to each other in first direction D1, of the plurality of buffer portions 200, are continuous to each other. A material of the plurality of buffer portions 200 will be described below.

Plate-shaped portion 300 is provided to cover the plurality of buffer portions 200. Plate-shaped portion 300 has a uniform thickness. Plate-shaped portion 300 extends in the horizontal direction. Plate-shaped portion 300 extends in first direction D1. When viewed in up-down direction Z, plate-shaped portion 300 intersects the plurality of cross members 3. Plate-shaped portion 300 is spaced apart from the plurality of cells 100. Examples of plate-shaped portion 300 include a surface pressure distribution board and the like. A material of plate-shaped portion 300 will be described below.

In the present embodiment, the plurality of buffer portions 200 are formed integrally with plate-shaped portion 300. The plurality of buffer portions 200 protrude downward from plate-shaped portion 300.

Power storage device 10 further includes a pack 400. Pack 400 houses the plurality of cells 100 having the plurality of buffer portions 200 provided thereon, and plate-shaped portion 300. That is, pack 400 houses the plurality of power storage modules 50. Pack 400 is fixable to vehicle body 2 of vehicle 1. Specifically, pack 400 is configured to be fixable to the frame members of vehicle body 2 of vehicle 1.

As shown in FIG. 3, in vehicle 1 according to the present embodiment, an end portion of pack 400 on one side in second direction D2 is fixed to left side member 5a by a first fastening member 6a such as a bolt. An end portion of pack 400 on the other side in second direction D2 is fixed to right side member 5b by a second fastening member 6b such as a bolt.

The end portion of pack 400 on one side in second direction D2 may be fixed to left side sill 4a. The end portion of pack 400 on the other side in second direction D2 may be fixed to right side sill 4b.

As shown in FIGS. 3 and 4, pack 400 is disposed below the plurality of cross members 3. Pack 400 extends in first direction D1. When viewed in up-down direction Z, pack 400 is disposed to intersect the plurality of cross members 3. Pack 400 also functions as a floor member that defines a vehicle compartment.

As shown in FIGS. 5 and 6, pack 400 includes an upper plate portion 410, a lower plate portion 420 and a peripheral wall portion 430. Upper plate portion 410 is disposed further above a plurality of plate-shaped portions 300. Lower plate portion 420 is disposed below power storage modules 50. Peripheral wall portion 430 extends downward from an outer perimeter end of upper plate portion 410. Peripheral wall portion 430 extends along the horizontal direction to surround the plurality of power storage modules 50. Peripheral wall portion 430 is connected to lower plate portion 420.

The material of the plurality of buffer portions 200 and plate-shaped portion 300 will now be described. In the present embodiment, the plurality of buffer portions 200 and plate-shaped portion 300 are made of a material that is higher in rigidity than a material of upper plate portion 410.

The specific material of the plurality of buffer portions 200 and plate-shaped portion 300 is not particularly limited. Each of the plurality of buffer portions 200 and plate-shaped portion 300 is preferably a resin member, for example. The resin member is preferably higher in heat resistance temperature than the material of upper plate portion 410. The resin member is preferably lower in thermal conductivity than the material of upper plate portion 410. Since the resin member is such a material, an increase in temperature in the vehicle compartment when power storage modules 50 generate heat abnormally can be suppressed.

The resin member that constitutes each of the plurality of buffer portions 200 and plate-shaped portion 300 may include a thermosetting resin. The resin member may be made of glass fiber reinforced plastic. The resin member may include a foaming resin. The heat resistance temperature of the foaming resin is preferably equal to or higher than 400° C.

Power storage device 10 may further include a plurality of restraint members 510 in each of the plurality of power storage modules 50. The plurality of restraint members 510 extend from one side to the other side of power storage module 50 in first direction D1. A load is applied to the plurality of cells 100 in first direction D1 by the plurality of restraint members 510. Relative positions of the plurality of cells 100 are fixed to each other by the plurality of restraint members 510. Each of the plurality of restraint members 510 covers four corners of each of the plurality of cells 100 when viewed in first direction D1.

In the present embodiment, power storage device 10 may further include a first adhesive 520 in each of the plurality of power storage modules 50. First adhesive 520 is disposed between upper plate portion 410 and plate-shaped portion 300. First adhesive 520 joins upper plate portion 410 to plate-shaped portion 300. Thus, plate-shaped portion 300 can suppress deformation of upper plate portion 410.

Power storage device 10 may further include a cooling plate 530. Cooling plate 530 is provided below the plurality of power storage modules 50. Cooling plate 530 may be provided above the plurality of power storage modules 50. A flow circuit (not shown) in which refrigerant such as air or a cooling liquid can flow is formed inside cooing plate 530.

Power storage device 10 may further include a tray 540. Tray 540 is provided below the plurality of power storage modules 50. Power storage device 10 may further include a second adhesive 550 in each of the plurality of power storage modules 50. Second adhesive 550 is disposed between the plurality of cells 100 and tray 540. Second adhesive 550 joins the plurality of cells 100 to tray 540.

Although the plurality of cells 100 are spaced apart from each other as shown in FIG. 8 for ease of description, the plurality of cells 100 may be in close contact with each other in first direction D1. Another member such as a spacer may be interposed between the plurality of cells 100.

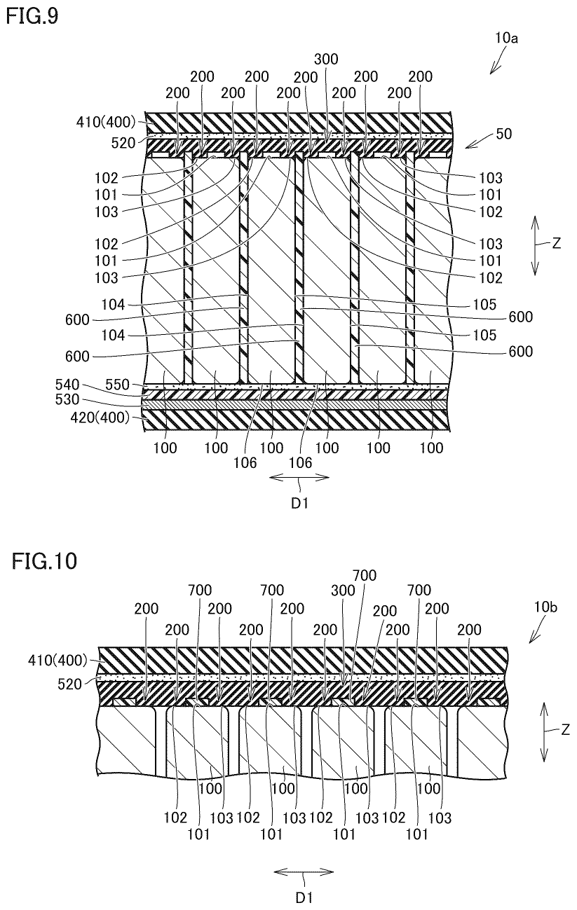

FIG. 9 is a cross-sectional view showing a power storage device according to a modification of the first embodiment of the present disclosure. FIG. 9 and the subsequent figures are illustrated in the same cross-sectional view as the cross-sectional view in the first embodiment shown in FIG. 8. As shown in FIG. 9, a power storage device 10a may further include a plurality of spacers 600 in each of the plurality of power storage modules 50. Each of the plurality of spacers 600 is disposed between corresponding two cells 100 adjacent to each other, of the plurality of cells 100. The plurality of spacers 600 are made of resin, for example. An end portion of each of spacers 600 may be disposed between buffer portions 200 provided on different cells 100 and being adjacent to each other in first direction D1, of the plurality of buffer portions 200.

As described above, power storage device 10 according to the first embodiment of the present disclosure is mountable on vehicle 1. Power storage device 10 includes: a plurality of cells 100; and a plurality of buffer portions 200. The plurality of cells 100 are arranged in first direction D1, first direction D1 being a direction along a horizontal direction. The plurality of buffer portions 200 are disposed on the plurality of cells 100. Each of the plurality of cells 100 includes upper surface portion 101 facing upward. Upper surface portion 101 includes first end edge 102 and second end edge 103. First end edge 102 is an end edge on one side in first direction D1. Second end edge 103 is an end edge on the other side in first direction D1. First end edge 102 and second end edge 103 extend along second direction D2, second direction D2 being a direction along the horizontal direction and orthogonal to first direction D1. The plurality of buffer portions 200 are spaced apart from each other on upper surface portions 101 of the plurality of cells 100, and at least one of the plurality of buffer portions 200 is provided at at least one of first end edge 102 and second end edge 103 of each of the plurality of cells 100.

According to the above-described configuration, a load input from above power storage device 10 can be transmitted through buffer portions 200 to at least one of first end edge 102 and second end edge 103 having relatively high rigidity, of upper surface portion 101 of each cell 100. Therefore, the rigidity of power storage device 10 against input of the load from above can be increased.

In addition, in the first embodiment, the plurality of buffer portions 200 are spaced apart from each other on upper surface portions 101 of the plurality of cells 100, and at least one of the plurality of buffer portions 200 is provided at first end edge 102 of each of the plurality of cells 100 and at least one of the plurality of buffer portions 200 is provided at second end edge 103 of each of the plurality of cells 100.

According to the above-described configuration, a load input from above power storage device 10 can be transmitted to both of first end edge 102 and second end edge 103 through buffer portions 200. Therefore, the rigidity of power storage device 10 against input of the load from above can be further increased.

In addition, in the first embodiment, buffer portions 200 provided on different cells 100 and being adjacent to each other in first direction D1, of the plurality of buffer portions 200, are continuous to each other.

According to the above-described configuration, input of a load to between first end edge 102 and second end edge 103 of each cell 100 can be suppressed and the rigidity of buffer portions 200 can be further increased.

In addition, power storage device 10 according to the first embodiment further includes plate-shaped portion 300. Plate-shaped portion 300 is provided to cover the plurality of buffer portions 200. The plurality of buffer portions 200 are formed integrally with plate-shaped portion 300.

According to the above-described configuration, a load input from above plate-shaped portion 300 is more reliably input to first end edge 102 and second end edge 103 of each cell 100 through plate-shaped portion 300 and the plurality of buffer portions 200. Therefore, the rigidity of power storage device 10 against input of the load from above can be more reliably increased.

### Second Embodiment

Next, a power storage device according to a second embodiment of the present disclosure will be described. The power storage device according to the second embodiment of the present disclosure is different from power storage device 10 according to the first embodiment of the present disclosure mainly in that the power storage device according to the second embodiment of the present disclosure includes elastic members. Description of the same configuration and effect as those of power storage device 10 according to the first embodiment of the present disclosure will not be repeated.

FIG. 10 is a partial cross-sectional view showing the power storage device according to the second embodiment of the present disclosure. As shown in FIG. 10, a power storage device 10b further includes a plurality of elastic members 700 in each of the plurality of power storage modules 50. Each of elastic members 700 is disposed on upper surface portion 101 of at least one of the plurality of cells 100 in a gap between the plurality of buffer portions 200.

According to the above-described configuration, when a load is input from the gap between buffer portions 200 through elastic member 700 to upper surface portion 101, elastic member 700 is deformed, whereby local input of the load to upper surface portion 101 can be suppressed.

Each of the plurality of elastic members 700 may be disposed on the upper surface portion of each of the plurality of cells 100 in a gap between the plurality of buffer portions 200.

### Third Embodiment

Next, a power storage device according to a third embodiment of the present disclosure will be described. The power storage device according to the third embodiment of the present disclosure is different from power storage device 10 according to the first embodiment of the present disclosure in terms of a configuration of the buffer portions. Description of the same configuration and effect as those of power storage device 10 according to the first embodiment of the present disclosure will not be repeated.

FIG. 11 is a partial cross-sectional view showing the power storage device according to the third embodiment of the present disclosure. As shown in FIG. 11, in a power storage device 10c according to the third embodiment, the plurality of buffer portions 200 are formed integrally with a pack 400c.

According to the above-described configuration, a load input from above pack 400c is more reliably input to first end edge 102 and second end edge 103 of each cell 100 through pack 400c and the plurality of buffer portions 200. In addition, it is unnecessary to provide another member between buffer portions 200 and pack 400c in the up-down direction. Therefore, the height of power storage device 10 can be reduced and the rigidity of power storage device 10 against input of the load from above can be more reliably increased.

Specifically, the plurality of buffer portions 200 are formed integrally with upper plate portion 410 of pack 400c. The plurality of buffer portions 200 protrude downward from upper plate portion 410 of pack 400c.

### Fourth Embodiment

Next, a power storage device according to a fourth embodiment of the present disclosure will be described. The power storage device according to the fourth embodiment of the present disclosure is different from power storage device 10a according to the modification of the first embodiment of the present disclosure in terms of a configuration of the buffer portions. Description of the same configuration and effect as those of power storage device 10a according to the modification of the first embodiment of the present disclosure will not be repeated.

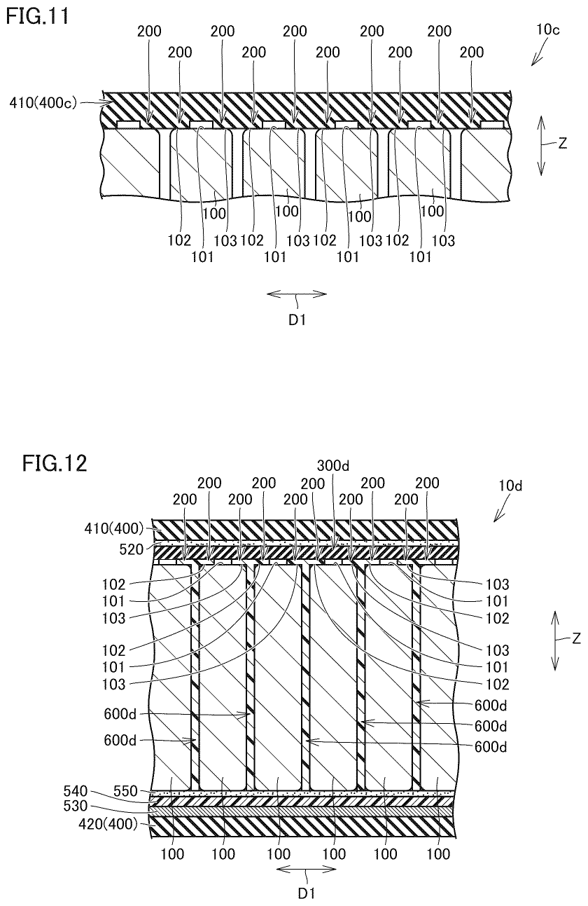

FIG. 12 is a cross-sectional view showing the power storage device according to the fourth embodiment of the present disclosure. In a power storage device 10d according to the fourth embodiment, a plurality of spacers 600d are formed integrally with the plurality of buffer portions 200.

According to the above-described configuration, an increase in the number of components caused by providing the plurality of buffer portions 200 in power storage device 10 including the plurality of spacers 600d can be suppressed.

A plurality of buffer portions 200 extend along first direction D1 from both sides of each of a plurality of spacers 600d in first direction D1. In the fourth embodiment, a plate-shaped portion 300d is formed by a member different from the plurality of buffer portions 200. However, plate-shaped portion 300d may also be formed integrally with the plurality of buffer portions 200.

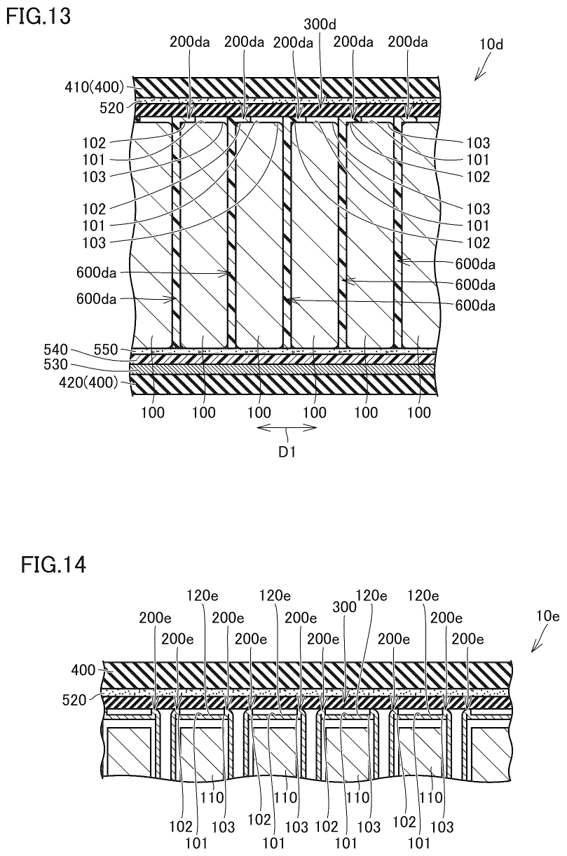

FIG. 13 is a cross-sectional view showing a power storage device according to a modification of the fourth embodiment of the present disclosure. As shown in FIG. 13, each of the plurality of buffer portions 200da may extend only on one side of each of the plurality of spacers 600da in first direction D1.

### Fifth Embodiment

Finally, a power storage device according to a fifth embodiment of the present disclosure will be described. The power storage device according to the fifth embodiment of the present disclosure is different from power storage device 10 according to the first embodiment of the present disclosure in terms of a configuration of the buffer portions. Description of the same configuration and effect as those of power storage device 10 according to the first embodiment of the present disclosure will not be repeated.

FIG. 14 is a partial cross-sectional view showing the power storage device according to the fifth embodiment of the present disclosure. As shown in FIG. 14, in a power storage device 10e according to the fifth embodiment, a plurality of buffer portions 200e are formed integrally with cell cases 120e by bending cell cases 120e of the plurality of cells 100 convexly outward.

According to the above-described configuration, an increase in the number of components caused by providing the plurality of buffer portions 200 in power storage device 10 can be suppressed.

In the fifth embodiment, a plate-shaped portion 300 is formed by a member different from the plurality of buffer portions 200e.

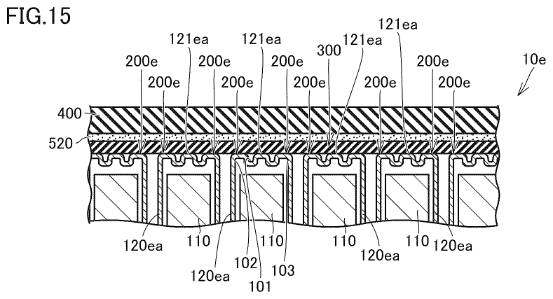

The bending shape of each of cell cases 120e is not limited to the shape shown in FIG. 14. FIG. 15 is a partial cross-sectional view showing a power storage device according to a sixth embodiment of the present disclosure. As shown in FIG. 15, each of the plurality of cells 100 may further have a convex portion 121ea formed by bending a part of upper surface portion 101 of a cell case 120ea convexly outward. Convex portion 121ea is in contact with plate-shaped portion 300.

In the description of the above-described embodiments, the features that can be combined may be combined mutually.

Although the embodiments of the present disclosure have been described, it should be understood that the embodiments disclosed herein are illustrative and non-restrictive in every respect. The scope of the present disclosure is defined by the terms of the claims, and is intended to include any modifications within the scope and meaning equivalent to the terms of the claims.

What is claimed is:

1. A power storage device mountable on a vehicle, the power storage device comprising:
a plurality of cells arranged in a first direction, the first direction being a direction along a horizontal direction; and
a plurality of buffer portions disposed on the plurality of cells, wherein
each of the plurality of cells includes an upper surface portion facing upward,
the upper surface portion includes a first end edge that is an end edge on one side in the first direction, and a second end edge that is an end edge on the other side in the first direction,
the first end edge and the second end edge extend along a second direction, the second direction being a direction along the horizontal direction and orthogonal to the first direction, and
the plurality of buffer portions are spaced apart from each other on the upper surface portions of the plurality of cells, and at least one of the plurality of buffer portions is provided at at least one of the first end edge and the second end edge of each of the plurality of cells.

2. The power storage device according to claim 1, wherein
the plurality of buffer portions are spaced apart from each other on the upper surface portions of the plurality of cells, and at least one of the plurality of buffer portions is provided at the first end edge of each of the plurality of cells and at least one of the plurality of buffer portions is provided at the second end edge of each of the plurality of cells.

3. The power storage device according to claim 1, wherein
buffer portions provided on different cells and being adjacent to each other in the first direction, of the plurality of buffer portions, are continuous to each other.

4. The power storage device according to claim 1, further comprising
a plate-shaped portion provided to cover the plurality of buffer portions, wherein
the plurality of buffer portions are formed integrally with the plate-shaped portion.

5. The power storage device according to claim 2, further comprising
an elastic member disposed on the upper surface portion of at least one of the plurality of cells in a gap between the plurality of buffer portions.

6. The power storage device according to claim 1, further comprising
a pack that houses the plurality of cells having the plurality of buffer portions provided thereon, the pack being fixable to a vehicle body of the vehicle, wherein
the plurality of buffer portions are formed integrally with the pack.

7. The power storage device according to claim 1, further comprising
a plurality of spacers, each of the plurality of spacers being disposed between corresponding two cells adjacent to each other, of the plurality of cells, wherein
the plurality of spacers are formed integrally with the plurality of buffer portions.

8. The power storage device according to claim 1, wherein
each of the plurality of cells includes an electrode assembly and a cell case that houses the electrode assembly, and
the plurality of buffer portions are formed integrally with the cell cases by bending the cell cases of the plurality of cells convexly outward.

9. The power storage device according to claim 1, further comprising
a plate-shaped portion provided to cover the plurality of buffer portions, wherein
the plurality of buffer portions are spaced apart from each other on the upper surface portions of the plurality of cells, and at least one of the plurality of buffer portions is provided at the first end edge of each of the plurality of cells and at least one of the plurality of buffer portions is provided at the second end edge of each of the plurality of cells,
buffer portions provided on different cells and being adjacent to each other in the first direction, of the plurality of buffer portions, are continuous to each other, and
the plurality of buffer portions are formed integrally with the plate-shaped portion.

10. The power storage device according to claim 9, further comprising
an elastic member disposed on the upper surface portion of at least one of the plurality of cells in a gap between the plurality of buffer portions.

11. The power storage device according to claim 1, further comprising
a pack that houses the plurality of cells having the plurality of buffer portions provided thereon, the pack being fixable to a vehicle body of the vehicle, wherein
the plurality of buffer portions are spaced apart from each other on the upper surface portions of the plurality of cells, and at least one of the plurality of buffer portions is provided at the first end edge of each of the plurality of cells and at least one of the plurality of buffer portions is provided at the second end edge of each of the plurality of cells,
buffer portions provided on different cells and being adjacent to each other in the first direction, of the plurality of buffer portions, are continuous to each other, and
the plurality of buffer portions are formed integrally with the pack.

12. The power storage device according to claim 1, further comprising
a plurality of spacers, each of the plurality of spacers being disposed between corresponding two cells adjacent to each other, of the plurality of cells, wherein
the plurality of buffer portions are spaced apart from each other on the upper surface portions of the plurality of cells, and at least one of the plurality of buffer portions is provided at the first end edge of each of the plurality of cells and at least one of the plurality of buffer portions is provided at the second end edge of each of the plurality of cells,
buffer portions provided on different cells and being adjacent to each other in the first direction, of the plurality of buffer portions, are continuous to each other, and
the plurality of spacers are formed integrally with the plurality of buffer portions.

13. The power storage device according to claim 8, wherein
the plurality of buffer portions are spaced apart from each other on the upper surface portions of the plurality of cells, and at least one of the plurality of buffer portions is provided at the first end edge of each of the plurality of cells and at least one of the plurality of buffer portions is provided at the second end edge of each of the plurality of cells.
